(19) United States
(12) Patent Application Publication
(10) Pub. No.: US 2026/0169281 A1
(43) Pub. Date: Jun. 18, 2026

(54) OPTICAL DEFLECTOR AND LASER SCANNER

(71) Applicant: STANLEY ELECTRIC CO., LTD., Tokyo (JP)

(72) Inventors: Nguyen Thanh TUNG, Tokyo (JP); Yoshiaki YASUDA, Tokyo (JP); Yoshiyuki ISHII, Tokyo (JP); Hideo OI, Tokyo (JP)

(73) Assignee: STANLEY ELECTRIC CO., LTD., Tokyo (JP)

(21) Appl. No.: 19/399,668

(22) Filed: Nov. 25, 2025

(30) Foreign Application Priority Data
Dec. 13, 2024 (JP) 2024-218849

(51) Int. Cl. G02B 26/08

(52) U.S. Cl. CPC G02B 26/0858

(57) ABSTRACT

An optical deflector constructed using a substrate having a first layer and a second layer, including: a mirror having a mirror plate constructed using the first layer and a rib constructed using the second layer, the rib disposed on the back surface side of the mirror plate; an actuator disposed around the mirror and spaced apart from the mirror; and a torsion bar constructed using the second layer, the torsion bar connecting the rib of the mirror to the actuator.

### CROSS-REFERENCE TO RELATED APPLICATION

This application claims the benefit of and priority to Japanese Patent Application No. 2024-218849 filed on Dec. 13, 2024, and the disclosure of which is hereby incorporated by reference herein in its entirety.

### BACKGROUND

### Technical Field

The present disclosure relates to an optical deflector and a laser scanner.

### Description of the Background Art

Japanese Laid-Open Patent Publication No. 2016-170376 describes an optical deflector including a mirror portion, a support portion, a pair of torsion bars that connect the mirror portion and the support portion on the rotation axis of the mirror portion, and a rib formed on the back surface of the mirror portion. In this optical deflector, each torsion bar has a pair of auxiliary portions extending from the torsion bar. The rib has a pair of rib extension portions that extend from the outer edge of the mirror portion, and the pair of rib extension portions are formed to extend onto and connect to the auxiliary portions.

However, this optical deflector leaves room for improvement in that the mirror has significant in-plane distortion.

In a specific aspect, it is an object of the present disclosure to provide a technology capable of reducing in-plane distortion of the mirror.

### SUMMARY

(1) An optical deflector according to one aspect of the present disclosure is an optical deflector constructed using a substrate having a first layer and a second layer, including:
   a mirror having a mirror plate constructed using the first layer and a rib constructed using the second layer, the rib disposed on the back surface side of the mirror plate;
   an actuator disposed around the mirror and spaced apart from the mirror; and
   a torsion bar constructed using the second layer, the torsion bar connecting the rib of the mirror to the actuator.
(2) A laser scanner according to one aspect of the present disclosure is a laser scanner including:
   the optical deflector according to the above-described (1);
   a light source that directs laser light toward the optical deflector; and
   a drive circuit that controls the operation of the optical deflector and the light source.

According to the above configurations, it is possible to reduce in-plane distortion of the mirror in an optical deflector. Further, it is possible to obtain a high-quality laser scanner equipped with a mirror with reduced in-plane distortion.

### BRIEF DESCRIPTION OF THE DRAWINGS

FIG. 1 is a diagram schematically illustrating the configuration of a laser scanner according to one embodiment.

FIG. 2 is a perspective view illustrating the configuration of an optical deflector according to one embodiment.

FIG. 3 is an enlarged perspective view of the main parts of the optical deflector.

FIG. 4A is an enlarged perspective view of the main parts of the optical deflector, viewed from the back surface side.

FIG. 4B is a diagram illustrating an enlarged view of the cross section taken along line A-A in FIG. 4A.

FIG. 5A is a diagram illustrating an example of the size of the mirror plate and the rib.

FIG. 5B is a diagram illustrating an example of the size of the connection portion between the torsion bar and the actuator.

FIG. 6 is a diagram illustrating the names of each part of the mirror plate and the rib.

FIG. 7 is a diagram illustrating each part of the torsion bar.

FIG. 8A is a planer view illustrating the rib shape of an optical deflector according to a first comparative example.

FIG. 8B is a cross-sectional view taken along line B-B in FIG. 8A.

FIG. 9A is a planer view illustrating the rib shape of an optical deflector according to a second comparative example.

FIG. 9B is a cross-sectional view taken along line C-C in FIG. 9A.

FIG. 10A is a planer view illustrating the rib shape of an optical deflector in a simplified form according to the present embodiment.

FIG. 10B is a cross-sectional view taken along line C-C in FIG. 10A.

FIG. 11A to FIG. 11D are diagrams illustrating the manufacturing process of an optical deflector according to one embodiment.

FIG. 12A to FIG. 12D are diagrams illustrating the manufacturing process of an optical deflector according to one embodiment.

### DESCRIPTION OF THE PREFERRED EMBODIMENTS

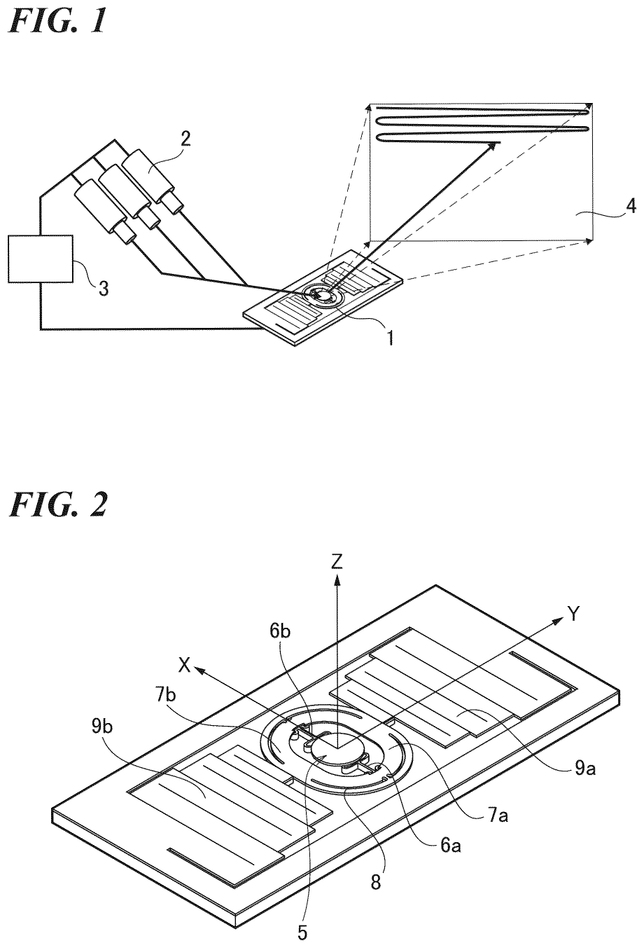

FIG. 1 is a diagram schematically illustrating the configuration of a laser scanner according to one embodiment. The laser scanner of the present embodiment is configured to include an optical deflector 1, a light source 2, and a control circuit 3. Laser light emitted from light source 2 enters optical deflector 1. Optical deflector 1 uses a mirror that operates under the control of control circuit 3 to freely change the direction of reflection of the laser light. As a result, the laser light reflected by optical deflector 1 can be scanned across a screen 4 to draw a desired image.

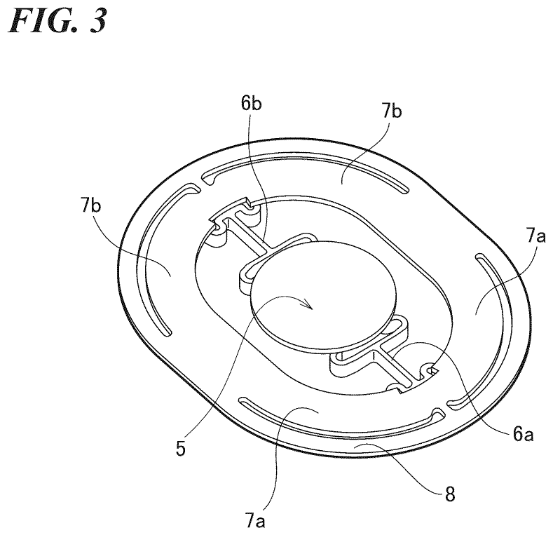

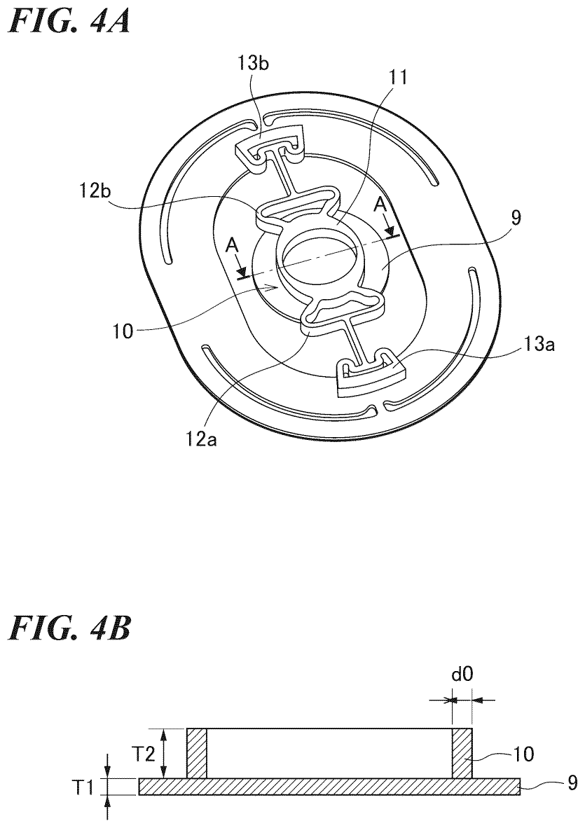

FIG. 2 is a perspective view illustrating the configuration of an optical deflector according to one embodiment. FIG. 3 is an enlarged perspective view of the main parts of the optical deflector. FIG. 4A is an enlarged perspective view of the main parts of the optical deflector, viewed from the back surface side. Optical deflector 1 according to the present embodiment is configured to include a mirror 5, torsion bars 6a and 6b, actuators 7a and 7b, an inner frame 8, and actuators 9a and 9b.

Mirror 5 reflects the incident laser light and is configured to be rotatable about two mutually perpendicular axes, the X-axis and the Y-axis, as shown in FIG. 2. In the present embodiment, mirror 5 is configured to be approximately circular in a planar view, but the planar shape is not limited thereto. As shown in FIG. 4A, mirror 5 is configured to include a mirror plate 9 and a rib 10. Optical deflector 1 of the present embodiment is constructed using a semiconductor substrate having an active layer, a support layer, and an insulating layer interposed therebetween. Specifically, mirror plate 9 is constructed using the active layer of an SOI (Silicon On Insulator) wafer, and rib 10 is constructed using the support layer of the SOI wafer. As is well known to those skilled in the art, an SOI wafer is a semiconductor substrate configured with a Si substrate (support layer) and a surface Si layer (active layer) with a thin insulating SiO₂ film (a BOX layer) interposed therebetween.

Rib 10 comprises a circular portion 11 (annular portion) located on the back surface side of mirror plate 9, and semi-ellipse portions 12a, 12b, (first connecting portions) each of which extends and protrudes toward the outside of mirror plate 9 (toward actuators 7a, 7b). Rib 10 functions to suppress in-plane distortion of mirror plate 9. Each semi-ellipse portion 12a, 12b shares the stress from torsion bars 6a, 6b, and functions to relieve the stress applied to mirror plate 9. Circular portion 11 and each semi-ellipse portion 12a, 12b are connected and forms as a single unit.

As shown in FIG. 3, etc., one end portion (first end portion) of the torsion bar 6a is connected to rib 10 (more specifically, semi-ellipse portion 12a) of mirror 5, and the other end portion (second end portion) is connected to actuator 7a. As shown in FIG. 4A, torsion bar 6a has a portion 13a which is the other end portion connected to actuator 7a, and a pillar-shaped portion connecting the first end portion and the second end portion.

Similarly, As shown in FIG. 4A, etc., one end portion of torsion bar 6b is connected to rib 10 (more specifically, semi-ellipse portion 12b) of mirror 5, and the other end portion (second end portion) is connected to actuator 7b. As shown in FIG. 4A, torsion bar 6b has portion 13b which is the other end portion connected to actuator 7b, and a pillar-shaped portion connecting the first end portion and second end portion.

Actuators 7a, 7b are arranged around the periphery of mirror 5 such that they collectively surround mirror 5 in a ring-shaped configuration in a planer view. Each actuator 7a, 7b is connected to each corresponding torsion bar 6a, 6b on its back surface side. Each actuator 7a, 7b is configured by placing a piezoelectric element constructed using piezoelectric materials such as PZT (lead zirconate titanate) on the surface not facing the support layer of the active layer. The piezoelectric material can be deformed by alternately applying opposite-phase voltages to each actuator 7a, 7b. This deformation is transmitted to mirror 5 via each torsion bar 6a, 6b, causing mirror 5 to rotate around the X-axis.

Actuators 9a, 9b are spaced apart in the Y-axis direction, sandwiching mirror 5 and other components. Each actuator 9a, 9b is connected to its respective actuator 7a, 7b via an inner frame 8 arranged around the actuators 7a, 7b. Each actuator 9a, 9b is configured by placing a piezoelectric element constructed using piezoelectric materials such as PZT on the surface not facing the support layer of the active layer. The piezoelectric material can be deformed by alternately applying voltage to each actuator 9a, 9b. This deformation is transmitted to mirror 5 via inner frame 8, causing mirror 5 to rotate around the Y-axis.

FIG. 4B is a diagram illustrating an enlarged view of the cross section taken along line A-A in FIG. 4A. As described above, mirror plate 9 is constructed using the active layer of the SOI wafer, and rib 10 is constructed using the support layer of the SOI wafer. Here, note that since the BOX layer is extremely thin compared to the active layer and the support layer, the BOX layer between the active layer and support layer is not shown in FIG. 4B. As shown, rib 10 is positioned to support the back surface side of mirror plate 9. As an example of the size, thickness T1 of mirror plate 9 can be 42.5 μm, thickness T2 of rib 10 can be 130 μm, and width d0 of rib 10 in a planar view (width in the cross section taken along line A-A) can be 50 μm.

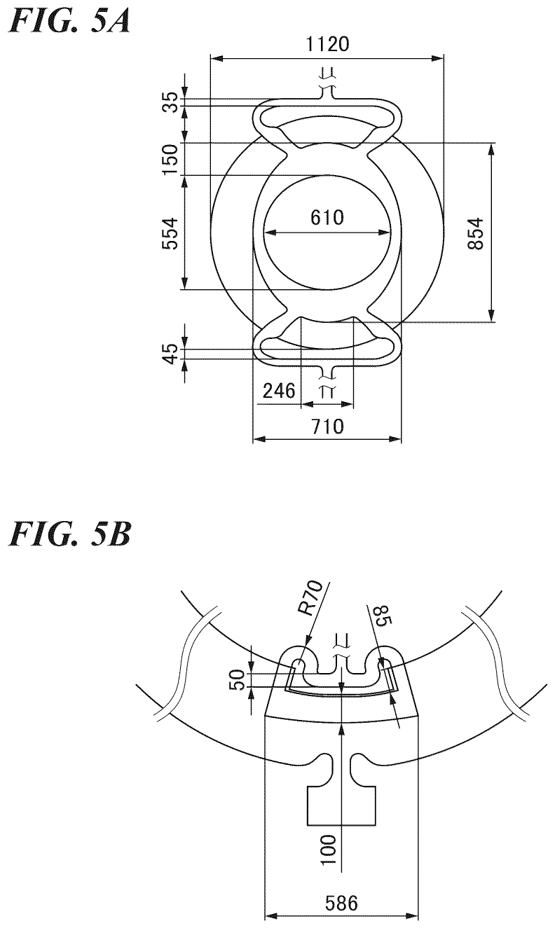

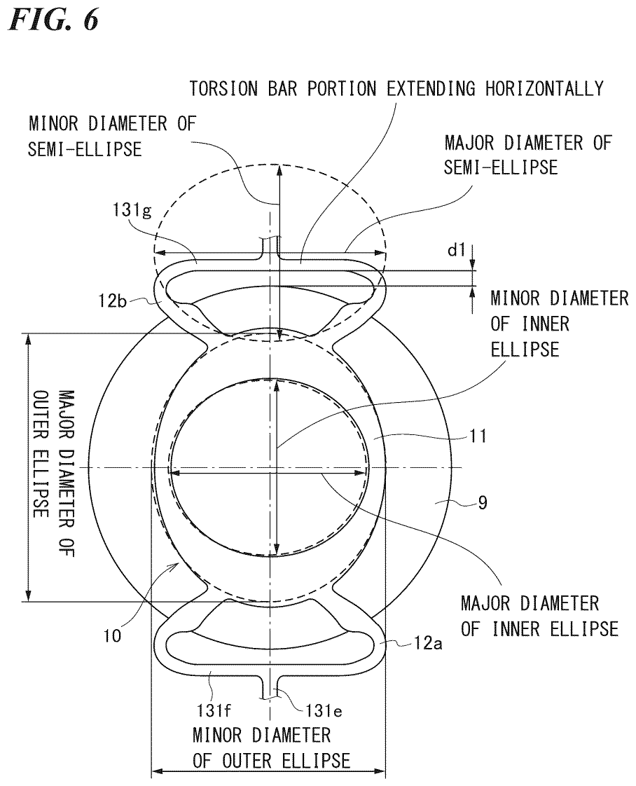

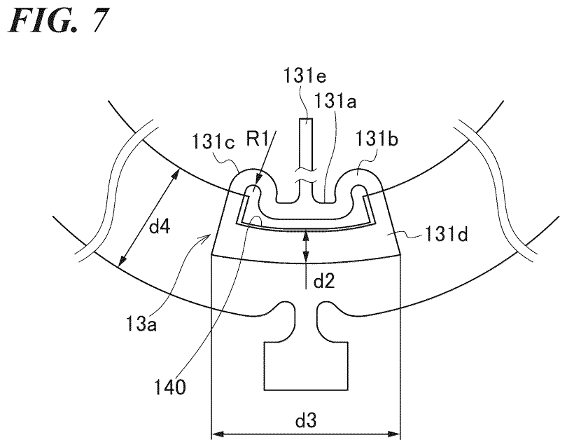

FIG. 5A is a diagram illustrating an example of the size of the mirror plate and the rib. FIG. 5A shows a planer view of mirror plate 9 and rib 10 viewed from the back surface side. FIG. 5B is a diagram illustrating an example of the size of the connection portion between the torsion bar and the actuator. FIG. 5B shows a planer view of the torsion bar and other components viewed from the back surface side. FIG. 6 is a diagram illustrating the names of each part of the mirror plate and the rib. FIG. 7 is a diagram illustrating each part of the torsion bar.

As shown in FIG. 5A and FIG. 6, rib 10 has a circular portion 11, which is an annular portion provided in a vertically elongated, approximately elliptical shape in the figures. Circular portion 11 is positioned so that its center roughly coincides with the center of mirror plate 9. Circular portion 11 has an opening cut out on the inside that is elliptical in shape and horizontally elongated in the figures. Hereinafter, the outline of this opening (the inner outline of the annular portion) will be referred to as the “inner ellipse”. Further, the outer edge of circular portion 11 of rib 10 in a planer view is elliptical in shape and vertically elongated in the figures, and hereinafter, the outline of this portion (the outer outline of the annular portion) will be referred to as the “outer ellipse”.

As shown in FIG. 6, the inner ellipse and outer ellipse each have a major diameter and a minor diameter. Further, each of the semi-ellipse portions 12a, 12b has a shape in a planer view that approximates an ellipse halved along its major diameter. Each of these semi-ellipse portions 12a, 12b also has a major diameter and a minor diameter, as shown in FIG. 6.

As shown in FIG. 5A, the diameter of mirror plate 9 can be 1120 μm, for example. In rib 10, the major diameter and the minor diameter of the outer ellipse can be 854 μm and 710 μm, respectively, for example. And the major diameter and the minor diameter of the inner ellipse can be 610 μm and 554 μm, respectively, for example.

In the figure, the distance between the upper outer edge of the inner ellipse and the upper outer edge of the outer ellipse can be 150 μm. Similarly, the distance between the lower outer edge of the inner ellipse and the lower outer edge of the outer ellipse can be 150 μm. The distance between each end of semi-ellipse portions 12a, 12b can be 246 μm.

The width of the portion of the torsion bar 6a connected to the lower side of semi-ellipse portion 12a in the figure, more specifically the portion 131f (first end portion) extending horizontally in the figure, can be set to 35 μm, for example. Similarly, the width of the portion of the torsion bar 6b connected to the upper side of the semi-ellipse portion 12b in the figure, more specifically the portion 131g (first end portion) extending horizontally in the figure, can be set to 35 μm, for example. Further, semi-ellipse portions 12a and 12b can be disposed to extend to a position 45 μm away from the outer edge of mirror plate 9, for example.

semi-ellipse portions 12a, 12b are connected to circular portion 11 at a position overlapping mirror plate 9 in a planer view, and are annular in shape consisting of a curved portion shaped like an ellipse that extends to a position where it does not overlap mirror plate 9, and a straight portion extending in the major diameter direction. Further, in the present embodiment, semi-ellipse portions 12a, 12b are thick from the point where they connect to circular portion 11 to the edge of mirror plate 9, and are thin at positions where they do not overlap mirror plate 9. They are thick at positions where they overlap mirror plate 9 to suppress distortion of mirror plate 9. They are thin at positions where they do not overlap mirror plate 9 to allow for flexible movement and relieve stress.

As shown in FIG. 7, portion 13a (second end portion) of the torsion bar 6a that connects to actuator 7a includes: a portion 131a (second connecting portion) located on the inner ellipse side and extending horizontally in a rod-like shape in the figure; portions 131b and 131c (protruding portions) connected to both sides of portion 131a, each of which is roughly U-shaped (roughly inverted U-shaped) in a planer view and extends inward of the actuator 7a; and a portion 131d (base portion) connected to each of the roughly U-shaped portions 131b and 131c and located on the outer ellipse side. Here, note that, although not shown, portion 13b has a similar configuration. Portions 131a, 131b, and 131c as a whole form a concave portion that is concave and annular in a planer view.

As shown in FIG. 5B, the width of portion 131a can be 50 μm, for example. The radius of the circular outer edge of each of portions 131 b and 131 c can be 70 μm, for example. Further, the width of portion 131 d can be 100 μm, for example. Furthermore, the width of a cutout portion 140 (refer to FIG. 7) can be 85 μm, for example. The cutout portion 140 is a portion of actuator 7a (7b) obtained by removing the portions that overlap, in a planer view, with portion 131a which is the bifurcated portion of rod-shaped portion 131e of portion 13a (13b), and with parts of portions 131b and 131c.

Next, the effect of rib 10 of optical deflector 1 of the present embodiment will be described.

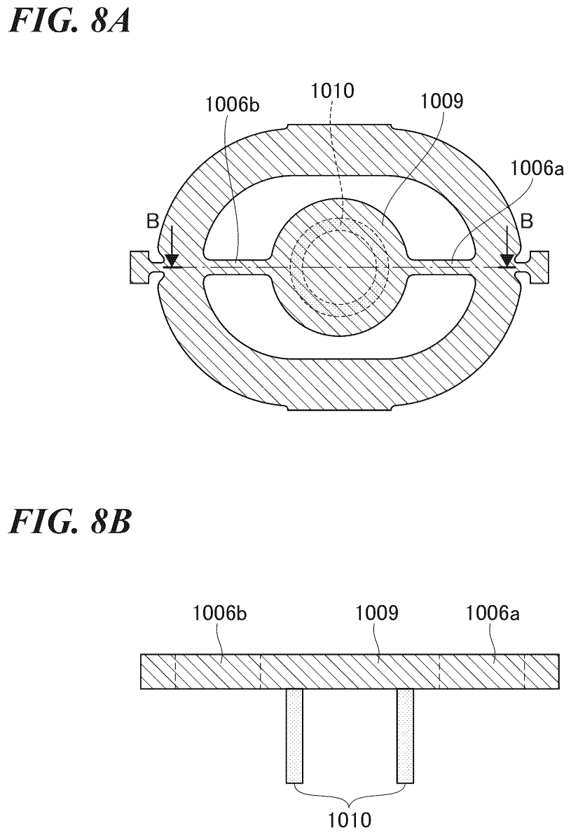

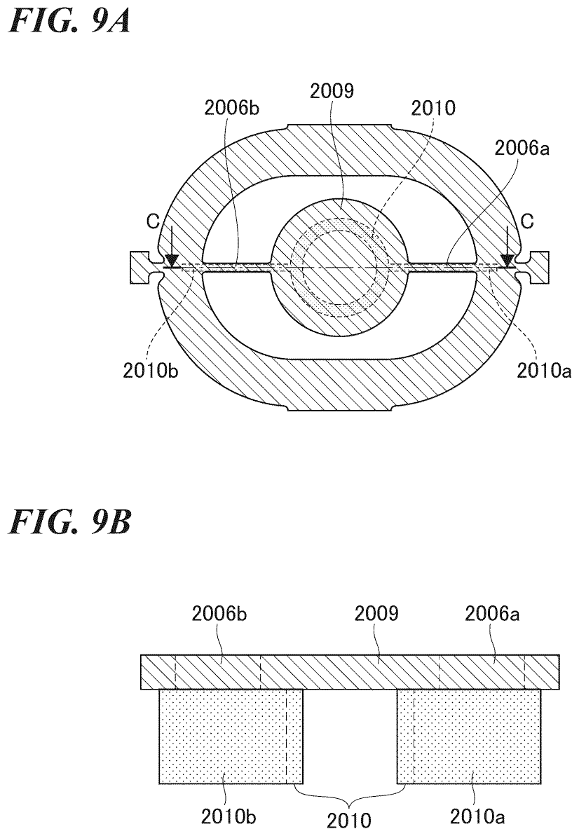

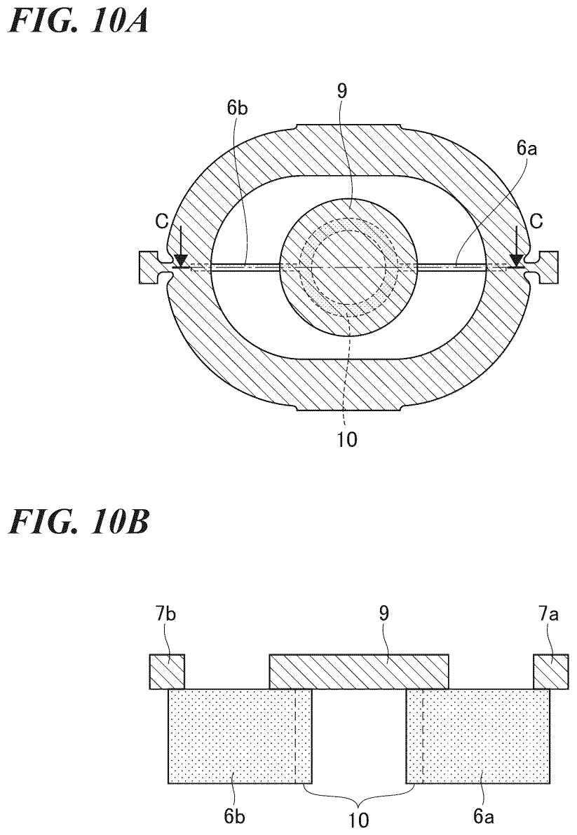

FIG. 8A is a planer view illustrating the rib shape of an optical deflector according to a first comparative example. FIG. 8B is a cross-sectional view taken along line B-B in FIG. 8A. FIG. 9A is a planer view illustrating the rib shape of an optical deflector according to a second comparative example. FIG. 9B is a cross-sectional view taken along line C-C in FIG. 9A. FIG. 10A is a planer view illustrating the rib shape of an optical deflector in a simplified form according to the present embodiment. FIG. 10B is a cross-sectional view taken along line C-C in FIG. 10A. Each figure shows the mirror (the mirror plate and the rib) and components related to the torsion bar.

In the first comparative example, a mirror plate 1009 and torsion bars 1006a and 1006b are constructed using an active layer. Then, as shown in FIG. 8A and FIG. 8B, a rib 1010 that is circular in a planer view is constructed using a support layer that is lower than the active layer in the figure. Rib 1010 is provided only on the back surface side of mirror plate 1009, and is not provided on the back surface sides of torsion bars 1006a and 1006b.

As in the first comparative example, in the second comparative example, a mirror plate 2009 and torsion bars 2006a, 2006b are constructed using an active layer. In the second comparative example, as shown in FIG. 9A and FIG. 9B, a rib 2010 and each of ribs 2010a, 2010b are constructed using a support layer that is lower than the active layer in the figure. In detail, rib 2010 is a circular portion in a planer view provided on the back surface side of mirror plate 2009, and each of the ribs 2010a, 2010b is a rectangular portion in a planer view provided on the back surface side of each of the torsion bars 2006a, 2006b.

In the simplified form of the present embodiment, mirror plate 9 is constructed using the active layer, but torsion bars 6a, 6b are constructed using the support layer rather than the active layer. Further, rib 10 is also constructed using the support layer, and each torsion bar 6a, 6b is connected to rib 10. Mirror plate 9 is not connected to the surrounding actuators or inner plate via the active layer, but is isolated like an island. That is, mirror plate 9 is supported by each torsion bar 6a, 6b and rib 10, which are constructed using the support layer, and is indirectly connected to surrounding actuators, etc. In this simplified form, each torsion bar 6a, 6b connecting the rib 10 to the actuators 7a, 7b has a first end portion connected to rib 10 and a second end portion connected to actuators 7a, 7b, and is configured in a long, narrow rectangular shape in a planer view between the first end portion and the second end portion.

The dynamic surface deformations of the first comparative example, the second comparative example, and the present embodiment (simplified form) described above were compared using RMS values. With regard to the present embodiment (simplified form), a size based on the numerical example described above was assumed, and simulations were performed assuming similar sizes for the first comparative example and the second comparative example. The results showed that the RMS value for the structure of the present embodiment (simplified form) was the lowest at 0.144λ, followed by the second comparative example at 0.268λ, and the first comparative example at 0.525λ, being the highest. In other words, as in the present embodiment, by constructing torsion bars 6a, 6b and ribs 10 using the support layer and by constructing mirror plate 9 using the active layer, the effects of torsion bars 6a, 6b twisting are mitigated. Consequently, it is considered that dynamic surface deformation, namely the in-plane distortion of mirror plate 9, is mitigated.

Next, the effect of rib 10 structure in the present embodiment will be described with reference to FIG. 6. As described above, in the present embodiment, rib 10 which is constructed by the support layer is disposed on the back surface side of mirror plate 9 which is constructed by the active layer. The portion of rib 10 located near the center of mirror plate 9 is annular and relatively wide in a planer view, and is disposed so as to surround the center of mirror plate 9, which is circular in a planer view. Thus, this makes it possible to suppress distortion of the edge of mirror plate 9, thereby suppressing dynamic surface deformation. Further, since rib 10 and mirror plate 9 are constructed by different layers (support layer/active layer), it is easy to increase the size and thickness of rib 10. Increasing the thickness of rib 10 also allows the thickness of the torsion bar 6a and other components to be increased. Therefore, this allows the spring constant of torsion bar 6a and other components to be increased, thereby alleviating stress while maintaining the resonance frequency. As a result, this allows the deflection angle of mirror plate 9 to be increased.

Here, the resonant frequency “f” can be expressed as f=(½π)×(k/J)^{1/2}. As can be seen from this equation, the resonant frequency “f” depends on the moment of inertia “J” of mirror 5 and the spring constant “k” of torsion bar 6a, etc. The resonant frequency “f” decreases as the moment of inertia increases. The resonant frequency “f” increases as the spring constant increases. The spring constant is dependent on the width, thickness, and length of torsion bar 6a, etc. ; the spring constant increases as the width or thickness increases, and decreases as the length increases.

Further, rib 10 has a semi-ellipse portion 12a (12b) which is connected to the torsion bar 6a (6b) and is arranged so as to bifurcate from circular portion 11. As a result, when deformation of torsion bar 6a etc. is transmitted to mirror plate 9, one of the two forks of the semi-ellipse portion 12a acts to push up mirror plate 9 from its back surface, while the other acts to pull down mirror plate 9 from its back surface. This allows the deformation transmitted from the torsion bar 6a etc. to be distributed and transmitted to mirror plate 9. This configuration provides a solution to the challenge of alleviating stress at the connection between mirror plate 9 and rib 10.

Here, a more preferable application forms of rib 10 of the present embodiment, which is disposed on the back surface of mirror plate 9, are listed below. Note that any one or more of the following embodiments may be adopted arbitrarily, and multiple forms may be adopted in any combination.
(1) The major axis of the outer ellipse and the minor axis of the inner ellipse are aligned (are in the same direction).
(2) The minor axis of the outer ellipse and the major axis of the inner ellipse are aligned (are in the same direction).
(3) The major axis of the outer ellipse is aligned (is in the same direction) with the Y-axis direction of the mirror plate.
(4) The minor axis of the outer ellipse is aligned (is in the same direction) with the X-axis direction of the mirror plate.
(5) The minor axis of the semi-ellipse is aligned (is in the same direction) with the major axis of the outer ellipse.
(6) The longitudinal direction of the horizontal direction portions of the torsion bar 6a, etc., is aligned with the minor axis of the semi-ellipse.
(7) The major diameter of the outer ellipse is greater than the radius of the mirror plate but smaller than its diameter.
(8) The minor diameter of the outer ellipse is greater than the radius of the mirror plate but smaller than its diameter.
(9) The major diameter of the inner ellipse is smaller than the minor diameter of the outer ellipse.
(10) The minor diameter of the inner ellipse is smaller than the major diameter of the outer ellipse.
(11) The major diameter of the semi-ellipse is greater than the minor diameter of the semi-ellipse and smaller than the diameter of the mirror plate.
(12) The minor diameter of the semi-ellipse is set so that d1>10 μm, where d1 is the distance between the horizontal direction portion of the torsion bar 6a, etc., and the outer edge of mirror plate 9.

Next, the effect of torsion bars 6a and 6b in optical deflector 1 of the present embodiment will be described with reference to FIG. 7. As described above, in the present embodiment, torsion bars 6a and 6b are also constructed by the active layer and are continuous with ribs 10 on the back surface of mirror plate 9. In other words, torsion bars 6a and 6b and ribs 10 are integrally formed. Further, torsion bars 6a and 6b have portions 13a and 13b that are connected to actuators 7a and 7b on the back surface side of inner frame 8.

In reference to portion 13a, portions 131b and 131c which are connected on both sides of portion 131a and each form a substantially U-shaped (or substantially inverted U-shaped) configuration, have their respective U-shaped bottom sides protruding inward relative to actuator 7a in a planer view. As shown in FIG. 7, portion 13a of torsion bar 6a connected to actuator 7a includes portion 131a (second connecting portion) located on the inner ellipse side and extending in a substantially rectangular shape in the horizontal direction within the figure in a planer view, portions 131b and 131c (protruding portions) connected by portion 131a, and portion 131d (base portion) connected to portions 131b and 131c. Portion 131d is connected to actuator 7a. Here, note that portion 13b has a similar configuration.

According to this configuration, when displacement from actuator 7a, etc. is transmitted to the pillar-shaped portion 131e, which connects the first end portion and second end portion in the torsion bar 6a, etc., it is possible to distribute and transmit the displacement to the respective portions 131b and 131c, which are separated from actuator 7a, etc. Therefore, it is possible to provide a solution to the challenge of alleviating (reducing) the stress applied to the SOI insulating film interposed between each part 131b, 131c and the actuator 7a, etc.

Here, more preferred application forms of portion 13 of torsion bar 6a, etc., of the present embodiment are listed below. Further, any one or more of the following forms may be adopted arbitrarily, and multiple forms may be adopted in any combination.
(1) The width of each of portions 131b and 131c is greater than the width of pillar-shaped portion 131e of torsion bar 6a.
(2) The radius R1 of the inner curve of each of portions 131b and 131c is greater than four times the width of each of portions 131b and 131c.
(3) The ratio of the width d2 of portion 131d to the width d4 of the support is 20% to 40%.
(4) The maximum width d3 of portion 13a is greater than six times the radius R1 of the inner curve.

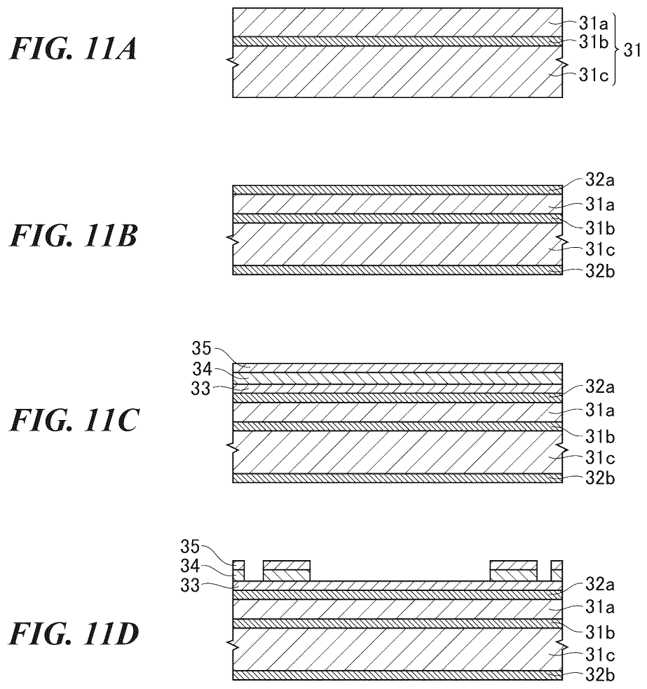

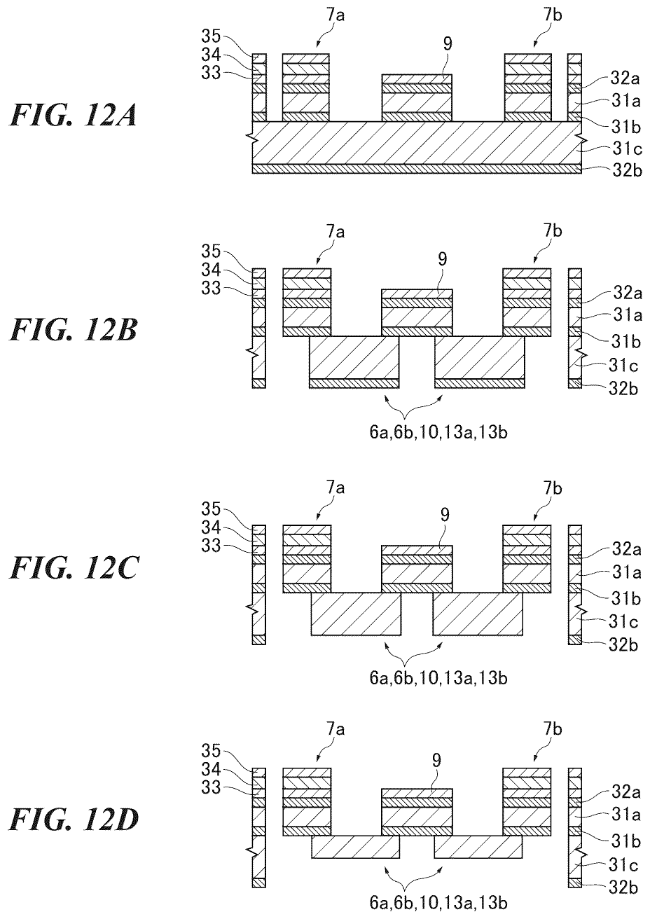

FIG. 11A to FIG. 11D and FIG. 12A to FIG. 12D are diagrams illustrating the manufacturing process of an optical deflector according to one embodiment. These diagrams illustrate a schematic representation of an area corresponding to a part of optical deflector 1. Here, note that, due to the need to show the oxide film, etc. of the SOI substrate, the thickness of each layer is expressed differently from the schematic cross-sectional view of optical deflector 1 described above.

As shown in FIG. 11A, an SOI substrate 31 is prepared. This SOI substrate 31 has an active layer 31a, a support layer 31c, and an oxide film 31b interposed therebetween.

As shown in FIG. 11B, thermal oxide films 32a and 32b are formed by oxidizing the front surface (active layer 31a side) and back surface (support layer 31c side) of SOI substrate 31 in a thermal oxidation furnace (diffusion furnace). Thermal oxide films 32a and 32b can have a thickness of 0.1 to 1 μm, for example.

Next, as shown in FIG. 11C, a lower electrode layer 33, a piezoelectric layer 34, and an upper electrode layer 35 are sequentially formed on the surface (active layer 31a side) of SOI substrate 31. Specifically, lower electrode layer 33 consisting of two metal thin films is formed on thermal oxide silicon film 32a, for example. As a material for lower electrode layer 33, titanium can be used for the first (lower) metal thin film, and platinum can be used for the second (upper) metal thin film. The thickness of each metal thin film can be approximately 30 to 100 nm for the first titanium layer, and 100 to 300 nm for the second platinum layer, for example. Next, piezoelectric layer 34 consisting of a single piezoelectric film is formed on lower electrode layer 33, for example. As a material for piezoelectric layer 34, PZT which is a piezoelectric material can be used, for example. Further, the thickness of the piezoelectric film can be approximately 0.3 μm to 15 μm, for example. Next, upper electrode layer 35 made of a single metal thin film is formed on piezoelectric layer 34, for example. As a material for upper electrode layer 35, platinum or gold is used, for example. The thickness of upper electrode layer 35 is approximately 10 to 200 nm, for example.

Next, as shown in FIG. 11D, upper electrode layer 35 and piezoelectric layer 34 are patterned to form the portions that will become piezoelectric elements such as actuator 7a, etc. Specifically, first, a resist material is patterned on upper electrode layer 35 using photolithography technology. Next, using the patterned resist material as a mask, upper electrode layer 35 and piezoelectric layer 34 are dry-etched by use of an RIE (Reactive Ion Etching) apparatus.

Next, as shown in FIG. 12A, lower electrode layer 33, thermal oxide film 32a, active layer 31a of the SOI substrate 31, and oxide film 31b are patterned to form mirror plate 9 and actuators 7a and 7b. First, a resist material is patterned using photolithography technology. Next, using the patterned resist material as a mask, by use of an RIE apparatus, lower electrode layer 33, thermal oxide film 32a, active layer 31a of SOI substrate 31, and oxide layer 31b are dry-etched.

Here, the metal thin film of mirror 5 may be provided separately from lower electrode layer 35. In that case, for example, materials such as gold, platinum, silver, or aluminum can be used. The thickness of the metal thin film can be approximately 100 to 500 nm, for example.

Next, as shown in FIG. 12B, thermal oxide film 32b and support layer 31c of SOI substrate 31 are patterned to form rib 10, torsion bars 6a, 6b, and portions 13a, 13b. First, a resist material is patterned using photolithography technology. Next, using the patterned resist material as a mask, by use of an RIE apparatus, thermal oxide film 32b and support layer 31c of SOI substrate 31 are dry-etched.

Next, as shown in FIG. 12C, the thermal oxide film 32b used for dry etching by use of an ICP (Inductively Coupled Plasma)-RIE apparatus is removed from rib 10, torsion bars 6a and 6b, and portions 13a and 13b.

Materials that can be used for the metal thin film include gold, platinum, silver, and aluminum, for example. The thickness of the metal thin film can be approximately 100 to 500 nm, for example.

Next, as shown in FIG. 12D, support layer 31c of SOI substrate 31 is etched using an RIE apparatus until the thickness of rib 10 and the thickness of torsion bars 6a and 6b each reach a predetermined value. Here, note that while the above manufacturing process uses dry etching, wet etching can also be used.

The optical deflector 1 is obtained through the above manufacturing process. In this way, optical deflector 1 can be formed integrally using a semiconductor planar process and a MEMS process, thereby, manufacturing becomes easier, enabling miniaturization, mass production, and improved yield. Furthermore, when incorporating optical deflector 1 into various devices, the entire device can also be formed integrally using a semiconductor planar process and a MEMS process, making it easy to incorporate optical deflector 1 into other devices.

According to the above embodiment, it is possible to reduce in-plane distortion of the mirror in an optical deflector. Further, it is possible to obtain a high-quality laser scanner equipped with a mirror with reduced in-plane distortion.

Here, note that the present disclosure is not limited to the above-described embodiment, and various modifications can be made within the scope of the gist of the present disclosure. For example, the conditions such as the shape and thickness of optical deflector 1 are not limited to those exemplified in the above embodiment.

The present application is based on, and claims priority from, JP Application Serial Number, 2024-218849 filed on Dec. 13, 2024, the disclosure of which is hereby incorporated by reference herein in its entirety.

### DESCRIPTION OF SYMBOLS

1: Optical deflector
2: Light source
3: Drive circuit
4: Screen
5: Mirror
6a, 6b: Torsion bar
7a, 7b: Actuator
8: Inner frame
9a, 9b: Actuator
11: Circular portion
12a, 12b: semi-ellipse portion

What is claimed is:

1. An optical deflector constructed using a substrate having a first layer and a second layer, comprising:
a mirror having a mirror plate constructed using the first layer and a rib constructed using the second layer, the rib disposed on the back surface side of the mirror plate;
an actuator disposed around the mirror and spaced apart from the mirror; and
a torsion bar constructed using the second layer, the torsion bar connecting the rib of the mirror to the actuator.

2. The optical deflector according to claim 1,
wherein the actuator includes a piezoelectric element disposed on the surface of the first layer that does not face the second layer.

3. The optical deflector according to claim 1,
wherein the substrate is a semiconductor substrate having an active layer, a support layer, and an insulating layer interposed between the active layer and the support layer, and
wherein the first layer is the active layer, and the second layer is the support layer.

4. The optical deflector according to claim 1,
wherein the torsion bar has a first end portion that connects to the rib and a second end portion that connects to the actuator, and is configured to have a rectangular shape in a planer view between the first end portion and the second end portion.

5. The optical deflector according to claim 1,
wherein the rib has an annular portion, and
wherein the annular portion is positioned so that its center substantially coincides with the center of the mirror plate.

6. The optical deflector according to claim 5,
wherein the rib further has two first connecting portions that extend from the annular portion toward the outside of the mirror plate in a planer view and extend in different directions from each other, and
wherein the torsion bar has a first end portion connected to the two first connecting portions, a second end portion connected to the actuator, and a pillar-shaped portion connecting the first end portion and the second end portion.

7. The optical deflector according to claim 1,
wherein the torsion bar has a first end portion connected to the rib, a second end portion connected to the actuator, and a pillar-shaped portion connecting the first end portion and the second end portion, and
wherein the second end portion has a base portion in contact with the actuator and a concave portion that is concave in a planer view and is connected to the pillar-shaped portion.

8. The optical deflector according to claim 7,
wherein the concave portion has two protruding portions that are substantially U-shaped in planer view and extend toward the inside of the actuator, and a second connecting portion that is substantially rectangular in a planer view and connects the two protruding portions, and
wherein the pillar-shaped portion is connected to the second connecting portion.

9. The optical deflector according to claim 8,
wherein the actuator has a cutout portion at a position overlapping the concave portion in a planer view.

10. The optical deflector according to claim 5,
wherein the annular portion has an outer contour and an inner contour that are both ellipses in a planer view, and
wherein the major axis of an outer ellipse corresponding to the outer contour is aligned with the minor axis of an inner ellipse corresponding to the inner contour, and the minor axis of the outer ellipse is aligned with the major axis of the inner ellipse.

11. The optical deflector according to claim 10,
wherein the major diameter of the outer ellipse is greater than the radius of the mirror plate and smaller than its diameter.

12. A laser scanner comprising:
the optical deflector according to claim 1;
a light source that directs laser light toward the optical deflector; and
a drive circuit that controls the operation of the optical deflector and the light source.
